(19) United States
(12) Patent Application Publication
(10) Pub. No.: US 2012/0027533 A1
(43) Pub. Date: Feb. 2, 2012

(54) Rotary Drive Device within a Rotary Cylinder

(76) Inventor: David R. Hall, Provo, UT (US)

(21) Appl. No.: 12/845,585

(22) Filed: Jul. 28, 2010

(51) Int. Cl. B23D 7/00

(52) U.S. Cl. 409/235

(57) ABSTRACT

In one aspect of the invention, a motorized machine comprises at least one rotary assembly supported by a frame of the machine. A rotary drive device is disposed within an inner diameter of the rotary assembly. The rotary drive device is configured to rotate the rotary assembly with respect to the frame.

### BACKGROUND OF THE INVENTION

The present invention relates to an apparatus for degrading natural and manmade formations. Moreover, the present invention is related to a heavy drum supporting an array of picks and a light weight machine combination for optimum performance in asphalt, mining, construction, drilling, and excavation industries.

U.S. Pat. No. 4,172,616 to Delli-Gatti, Jr., which is herein incorporated by reference for all that it contains, discloses a cutting drum for a mining machine that requires only a single supporting arm, and single interior motor for rotation of the cutting drum. The drum has two body portions which are spaced apart a distance sufficient to receive the supporting arm along the axis of the drum. A cutting chain is operatively connected by sprocket teeth to each of the body portions, one of the body portions being driven by a shaft of the interior motor through reduction planetary gears. Only a single stage reduction need to be provided. One of the body portions may be formed so that it is longitudinally reciprocal along the axis of the drum to vary the cutting height or width.

U.S. Pat. No. 5,382,084 to Diver, which is herein incorporated by reference for all that it contains, discloses an axially rotatable groundworking implement mountable to a host vehicle. The groundworking implement is powered by two hydraulic motors between the side ends of the groundworking implement. The shaft of each motor includes a bore which functions as either the hydraulic fluid input port or output port for that motor. Each hydraulic motor shaft is nonrotatably affixed to a groundworking implement protective cover. The groundworking implement can be removed from its supporting mechanism without detaching the motor from the work implement.

U.S. Pat. No. 7,387,345 B2 to Hall, which is herein incorporated by reference for all that it contains, discloses a degradation drum comprising a generally cylindrical body comprising inner and outer diameters. At least one degradation assembly is disposed on the outer diameter and it comprises a holder and a pick shank secured within a bore of the holder. At least one lubricant reservoir is disposed within the inner diameter and is in fluid communication with the bore of the holder through a fluid pathway. In some embodiments, the lubricant reservoir maintains a fluid pressure on the pick shank.

### BRIEF SUMMARY OF THE INVENTION

In one aspect of the invention, a motorized machine comprises at least one rotary assembly supported by a frame of the machine. A rotary drive device is disposed within an inner diameter of the rotary assembly. The rotary drive device is configured to rotate the rotary assembly with respect to the frame.

The rotary assembly may be a degradation drum with a plurality of cutting elements. The rotary assembly may also be a compactor. The rotary drive device may be an electric motor, an axial vector engine, wankel engine, or hydraulic motor. The rotary drive device may be interlocked within an inner diameter of the rotary assembly. The rotary drive device may comprise a connecting rod that connects to the inner surface of the rotary assembly. The rotary drive device may comprise a gear set that connects to the inner surface of the rotary assembly. The rotary assembly may further comprise a hydraulic reservoir. The hydraulic reservoir may be connected to a hydraulic circuit supported by the frame of the machine.

The rotary drive device may be in electrical communication with a power source supported by the frame of the machine via an electrically conductive medium. The electrically conductive medium may comprise a swivel joint located along a rotational axis of the rotary assembly. The rotary assembly may weigh at least 30 percent of the total weight of the motorized machine. The machine may comprise a light truss that supports the rotary drive device. The truss may comprise carbon fiber, aluminum, aerogels, metal matrix composites, or combinations thereof. The rotary drive device may be controlled by an operator via a control panel, remote control, or combinations thereof. The rotary drive device may be powered by an external power source. The rotary drive device may be held stationary with respect to the frame.

A milling machine may comprise at least one milling drum supported by a frame of the machine. An engine may be disposed within an inner diameter of the drum. The engine may be configured to rotate the drum with respect to the frame. A combined weight of the engine and the drum may amount to at least 30 percent of the total weight of the milling machine.

### BRIEF DESCRIPTION OF THE DRAWINGS

FIG. 1 is an orthogonal diagram of an embodiment of a milling machine.

FIG. 2a is a perspective diagram of an embodiment of a degradation drum.

FIG. 2b is a cross-sectional diagram of an embodiment of a degradation drum.

FIG. 3a is a perspective diagram of another embodiment of a degradation drum.

FIG. 3b is a cross-sectional diagram of another embodiment of a degradation drum.

FIG. 4 is an orthogonal diagram of another embodiment of a degradation drum.

FIG. 5a is a perspective diagram of another embodiment of a degradation drum.

FIG. 5b is a cross-sectional diagram of another embodiment of a degradation drum.

FIG. 6 is an orthogonal diagram of an embodiment of milling machine and a truck.

FIG. 7a is a perspective diagram of another embodiment of a degradation drum.

FIG. 7b is a cross-sectional diagram of another embodiment of a degradation drum.

FIG. 8 is a perspective diagram of another embodiment of a degradation drum.

FIG. 9 is an orthogonal diagram of an embodiment of a milling machine.

FIG. 10 is an orthogonal diagram of another embodiment of a degradation drum.

FIG. 11a is a perspective diagram of another embodiment of a degradation drum.

FIG. 11b is a cross-sectional diagram of another embodiment of a degradation drum.

FIG. 12 is an orthogonal diagram of an embodiment of a mining machine.

FIG. 13 is a perspective diagram of an embodiment of a steam roller.

### DETAILED DESCRIPTION OF THE INVENTION AND THE PREFERRED EMBODIMENT

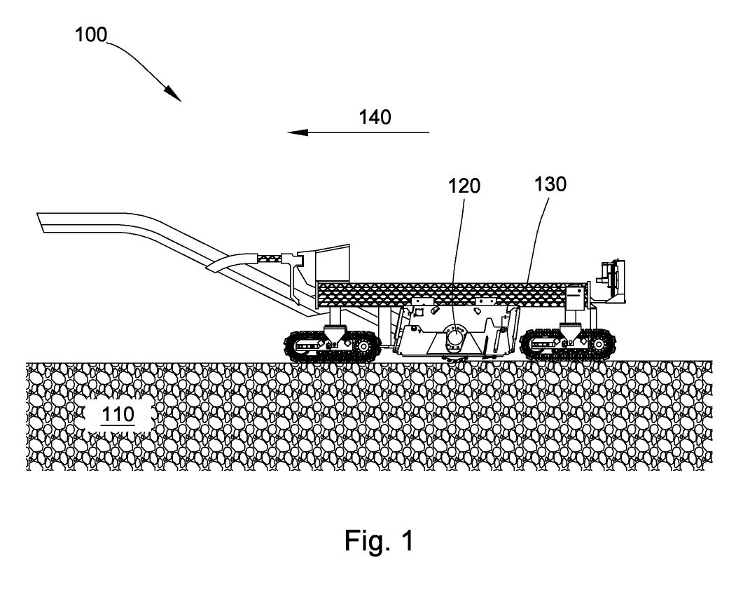

FIG. 1 is an orthogonal diagram of an embodiment of a milling machine 100. The milling machine 100 may be an asphalt planar used to degrade man-made formations 110 such as pavement prior to placement of a new layer of pavement. A degradation drum 120 may be attached to the underside of the milling machine 100. The degradation drum 120 may comprise an inner diameter and an outer diameter. The outer diameter may comprise a plurality of cutting elements. A holder, such as a block welded or bolted to the drum 120 may hold the cutting elements at an angle offset from a direction of rotation of the drum 120, such that the cutting elements engage the formation 110 at a preferential angle. The milling machine 100 may further comprise a truss structure 130 comprising a light weight material such as carbon fiber, aluminum, aerogels, metal matrix composites, or combinations thereof. The truss structure 130 may reduce the weight of the milling machine 100 without compromising its strength. The arrow 140 shows the direction of travel of the machine 100.

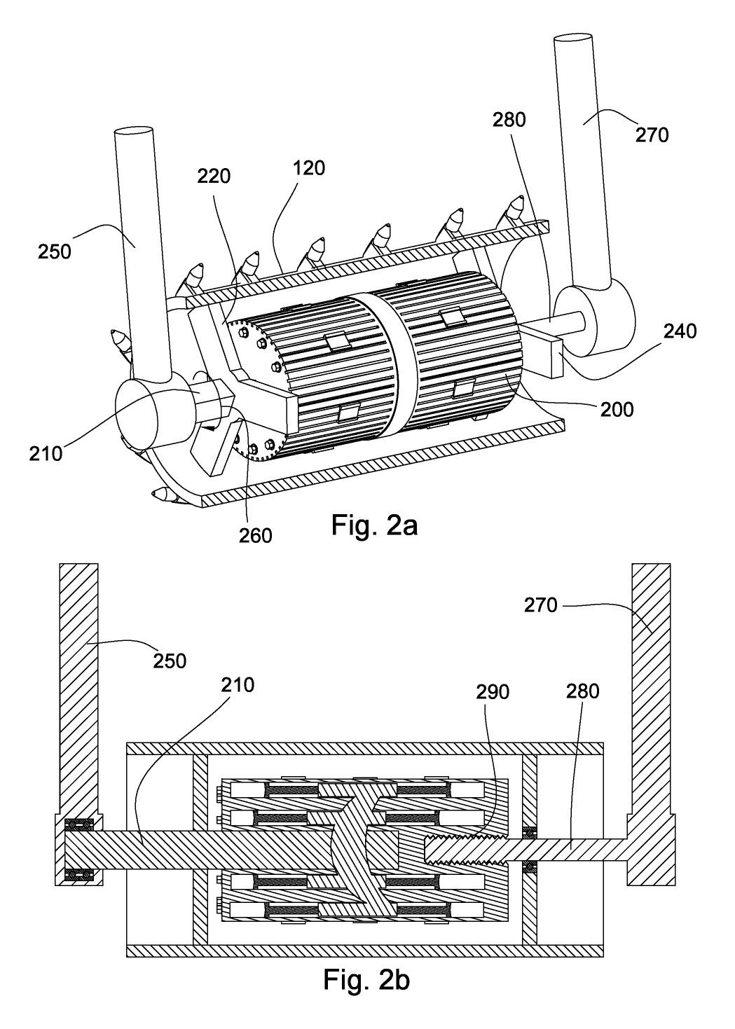

FIG. 2a discloses a perspective diagram of an embodiment of the degradation drum 120 comprising an axial vector engine 200 interlocked within the inner diameter of the drum 120. An axial vector engine 200 is a type of reciprocating engine that replaces the common crankshaft with a circular plate. One end of the engine 200 may comprise a rotating shaft 210. The direction of rotation of the shaft 210 is shown by an arrow 260. The rotating shaft 210 may be connected to a first connecting rod 220 that connects the engine 200 to the inner diameter of the drum 120, thereby transferring the torque from the shaft 210 of the engine 200 to the drum 120. The shaft 210 may comprise a square cross-section such that the first connecting rod 220 may rotate along with the shaft 210. In some embodiments, the shaft 210 and the first connecting rod 220 may comprise key and keyway mechanism. The end of the rotating shaft 210 may be connected to an axle 250 of the degradation drum 120. The first connecting rod 220 and a second connecting rod 240 may be connected to the inner surface of the drum 120 by a mechanism such as welding, bolt, or combinations thereof. Other end of the engine 200 may also comprise a non-rotating shaft 280 supported by the second connecting rod 240 and a second axle 270 of the degradation drum 120. The non-rotating shaft 280 may comprise a threaded end 290 that fits inside the engine 200. Such an embodiment of the degradation drum 120 is believed to rotate the drum 120 as well as increase the weight of the drum 120.

Referring to FIG. 2b, the rotating shaft 210 may be connected to the first axle 250 by a bearing mechanism such that the shaft 210 is free to rotate. The second connecting rod 240 may also be connected to the non-rotating shaft 280 by a bearing mechanism. The engine 200 may extend longitudinally through the body of the degradation drum 120. The cylindrical shape of the engine 200 may help to place the engine 200 easily inside the degradation drum 120. In some embodiments, the shape of the engine 200 may be rounded, rectangular, or combinations thereof. The engine 200 may occupy most of the volume of the drum 120, thereby increasing the weight of the drum 120 drastically. The engine 200 may be controlled by an operator via a control panel, remote control, or combinations thereof. The control panel may be positioned within the milling machine 100 or held separately.

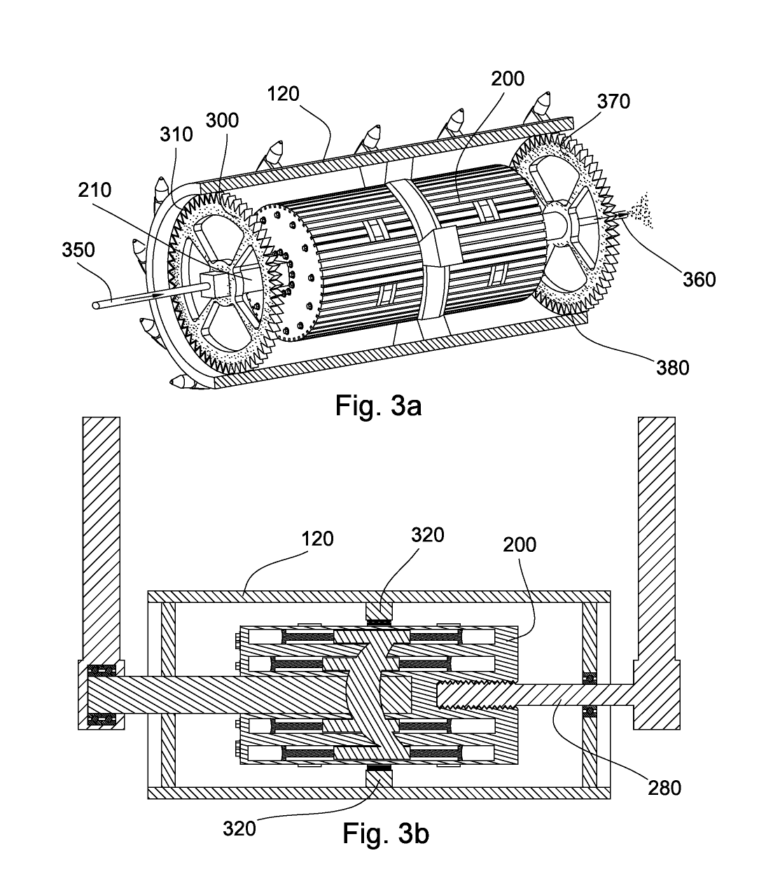

FIG. 3a discloses a perspective diagram of another embodiment of the degradation drum 120 comprising the axial vector engine 200 and a plurality of gear sets. A first gear set may comprise a first gear wheel 300 attached to the rotating shaft 210 of the engine 200 and a second gear wheel 310 attached to the inner diameter of the drum 120. The torque produced by the shaft 210 of the engine 200 may be transferred to the drum 120 via the first gear set. The first gear wheel 300 and second gear wheel 310 may remain interlocked while the drum 120 is in operation. The first gear wheel 300 may comprise a solid disc structure, optimized structure, or combinations thereof. The weight of the degradation drum 120 may also depend on a thickness of the gear wheels. The gear wheels may be individually replaceable. A second gear set may also comprise a first gear wheel 370 and a second gear wheel 380. The gear sets may help to stabilize the engine, and increase the weight of the drum 120 as well. The axial vector engine 200 may comprise an intake port 350 and an exhaust port 360.

Referring to FIG. 3b, the axial vector engine 200 may be further supported by a support 320. The support 320 may be connected to the engine 200 by a bearing mechanism such that the support 320 may rotate when the drum 120 rotates while the engine 200 remains stationary. The second gear set may be connected to the non-rotating shaft 280 by a bearing mechanism. Such an embodiment may keep the engine 200 stable while the drum 120 is rotating, and increase the weight of the drum 120.

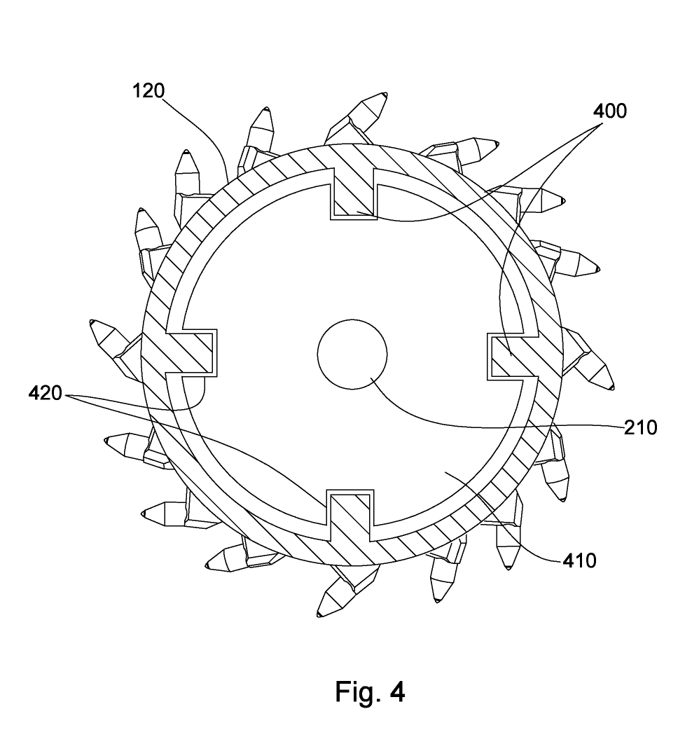

Referring to FIG. 4, an orthogonal diagram of an embodiment of the degradation drum 120 comprising the engine 200 is disclosed. The inner diameter of the degradation drum 120 may comprise a plurality of fins 400. The shaft 210 of the engine 200 may be connected to a circular disc 410 comprising a plurality of slots 420. The fins 400 may interlock with the slots 420 while the drum 120 is in operation, thereby transferring torque from the shaft 210 to the drum 120. The circular disc 410 may be welded to the shaft 210. Thus, the drum 120 may rotate as long as the shaft 210 of the engine 200 rotates.

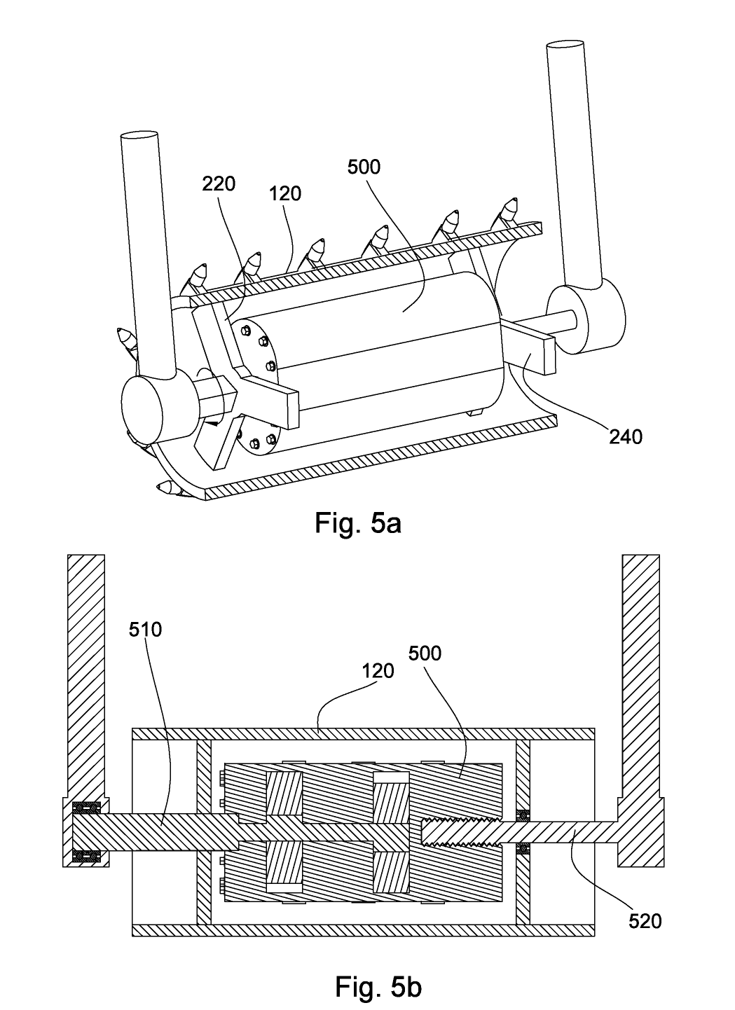

Referring to FIG. 5a, a wankel engine 500 inside the degradation drum 120 is disclosed. The wankel engine 500 is a type of internal combustion engine which uses a rotary design to convert pressure into a rotating motion instead of using reciprocating pistons. The engine 500 may be supported by the connecting rods 220, 240. FIG. 5b discloses a cross-sectional diagram on an embodiment of the drum 120 with the wankel engine 500 interlocked inside the drum 120. The engine 500 may also comprise a rotating shaft 510 and a non-rotating shaft 520. Such an embodiment is believed to increase the weight of the drum 120 such that the drum 120 weighs at least 30 percent of the total weight of the machine 100. In some embodiments, the weight of the drum 120 may exceed 50 percent of the total weight of the machine 100.

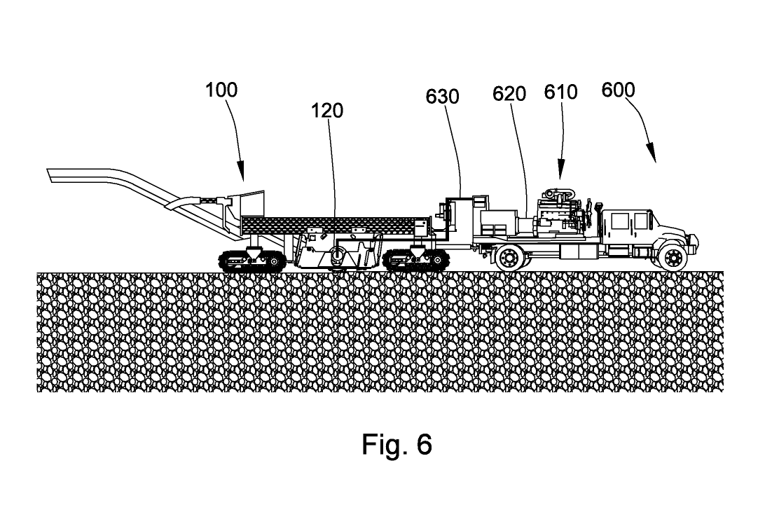

FIG. 6 discloses the milling machine 100 comprising a degradation drum 120 in connection with a truck 600 comprising a diesel engine 610 and a generator 620. The degradation drum 120 may comprise a rotary drive device such as a motor. A cable 630 may connect the rotary drive device to the diesel engine 610 and the generator 620. Thus, the rotary drive device may be powered by the diesel engine 610 placed on the back of the truck 600. Both milling machine 100 and the truck 600 may move simultaneously while the drum 120 is in operation. Thus, the degradation drum 120 may also be powered by an external source such as the diesel engine 610.

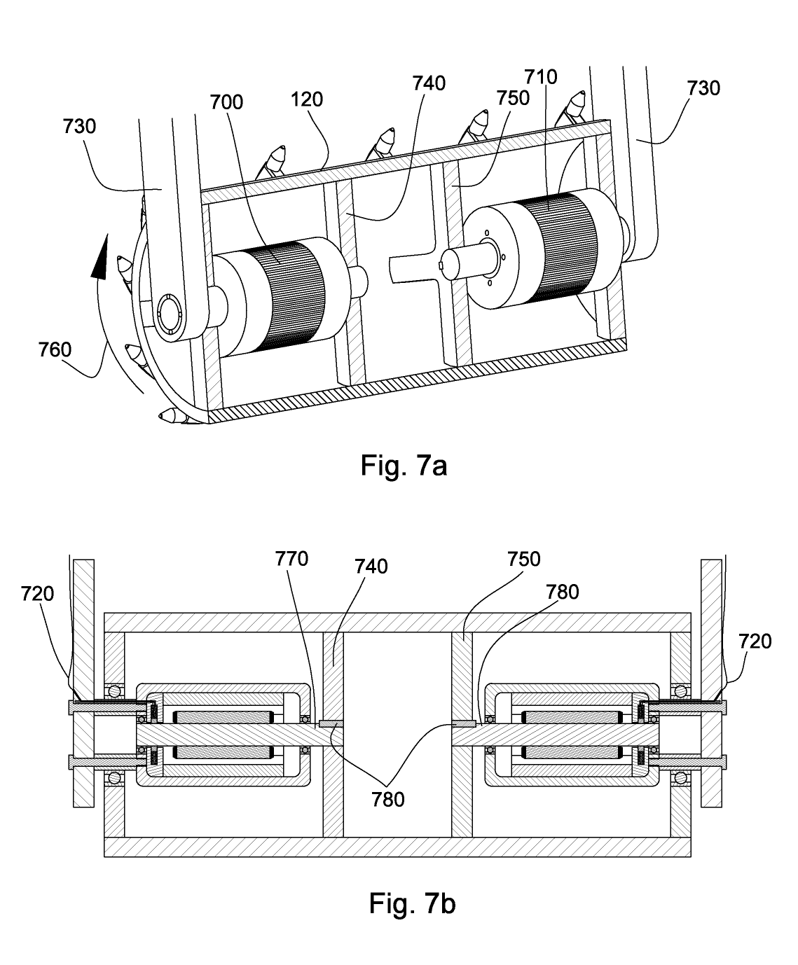

FIG. 7a discloses the degradation drum 120 comprising a plurality of electric motors 700, 710 as the rotary drive device. The electric motors 700, 710 may generate enough torque to rotate the drum 120. The electric motors 700, 710 may be powered by an external device such as the diesel engine 610 shown in FIG. 6. The electric motors 700, 710 may be supported by connecting rods 740, 750. The rotation of the drum 120 is shown by an arrow 760. The electric motors 700, 710 may comprise a swivel wire connection located at an axle 730 of the degradation drum 120 as shown in FIG. 7b. Such an embodiment may prevent twisting of wires 720 while the degradation drum 120 is rotating. The motors 700, 710 may comprise shafts 770, 780 connected to the connecting rods 740, 750 by a key and keyway mechanism 780. Such a mechanism may transfer the torque from the shaft 770, 780 to the drum 120, thereby rotating the drum 120. The plurality of electric motors 700, 710 may increase the weight of the drum 120.

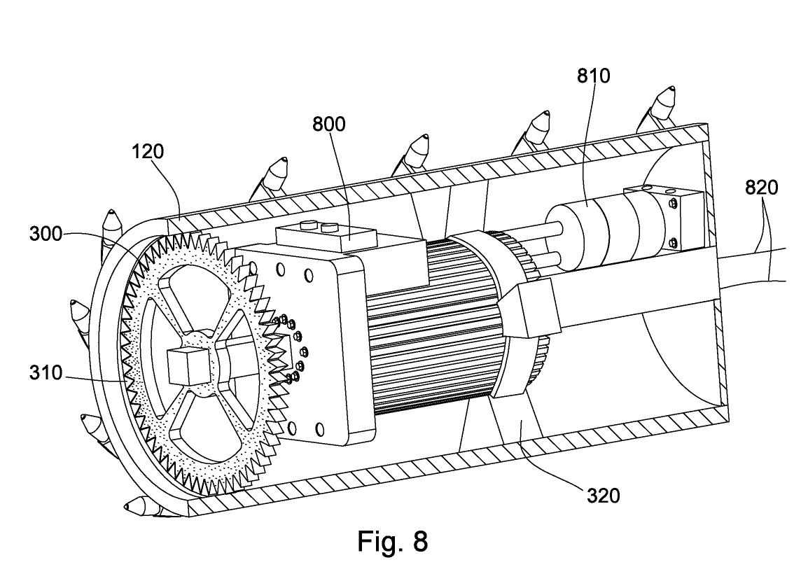

Referring to FIG. 8, the degradation drum 120 comprising a hydraulic motor 800 is disclosed. The hydraulic motor 800 may be powered by an external device such as the diesel engine 610 shown in FIG. 5. The hydraulic motor 800 is believed to generate enough torque to rotate the degradation drum 120. The hydraulic motor 800 may be connected to a hydraulic pump 810 which is further connected to the external power source via wires 820 through the axle of the degradation drum 120. The hydraulic motor 800 along with the hydraulic pimp 810 and the gear wheels 300, 310 may increase the weight of the degradation drum 120. The hydraulic motor 800 may be further supported by the support 320 comprising a bearing mechanism. The hydraulic motor 800 and the hydraulic pump 810 may add weight to the degradation drum 120.

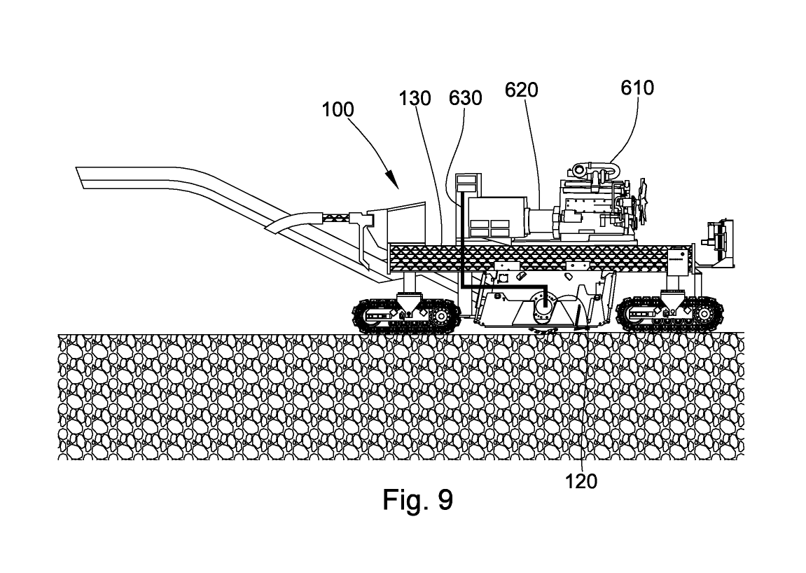

FIG. 9 discloses the milling machine 100 comprising a diesel engine 610 and a generator 620. The milling machine 100 may also comprise a truss structure 130. A degradation drum 120 may be attached to the underside of the milling machine 100. The degradation drum 120 may comprise a rotary drive device such as a motor to rotate the drum 120. The degradation drum 120 may be connected to the diesel engine 610 via cable 630. Such an embodiment may avoid the necessity of using an extra vehicle to carry the engine 610 and the generator 620.

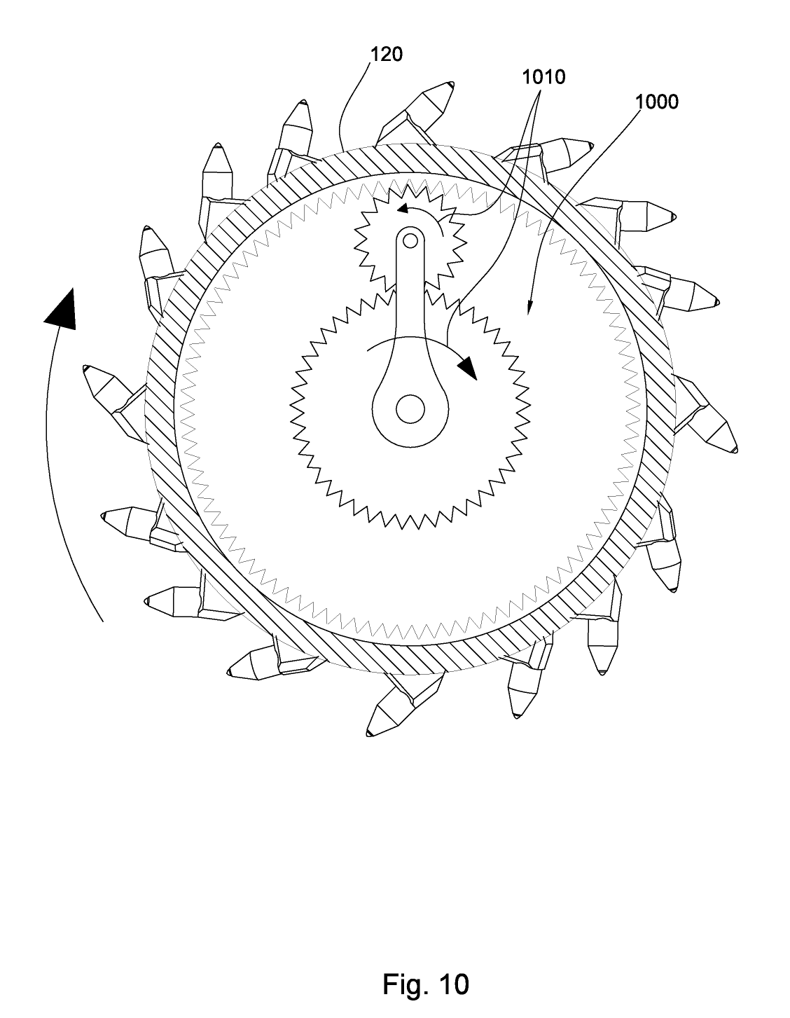

Referring to FIG. 10, an orthogonal diagram of an embodiment of a degradation drum 120 comprising a gear box 1000 is disclosed. The gear box 1000 may comprise a plurality of gear wheels of same or different diameters. The gear box 1000 may allow an operator of the machine 100 to adjust the rotational speed of the degradation drum 120. The rotation of the gear wheels inside the gear box 1000 is shown by arrows 1010.

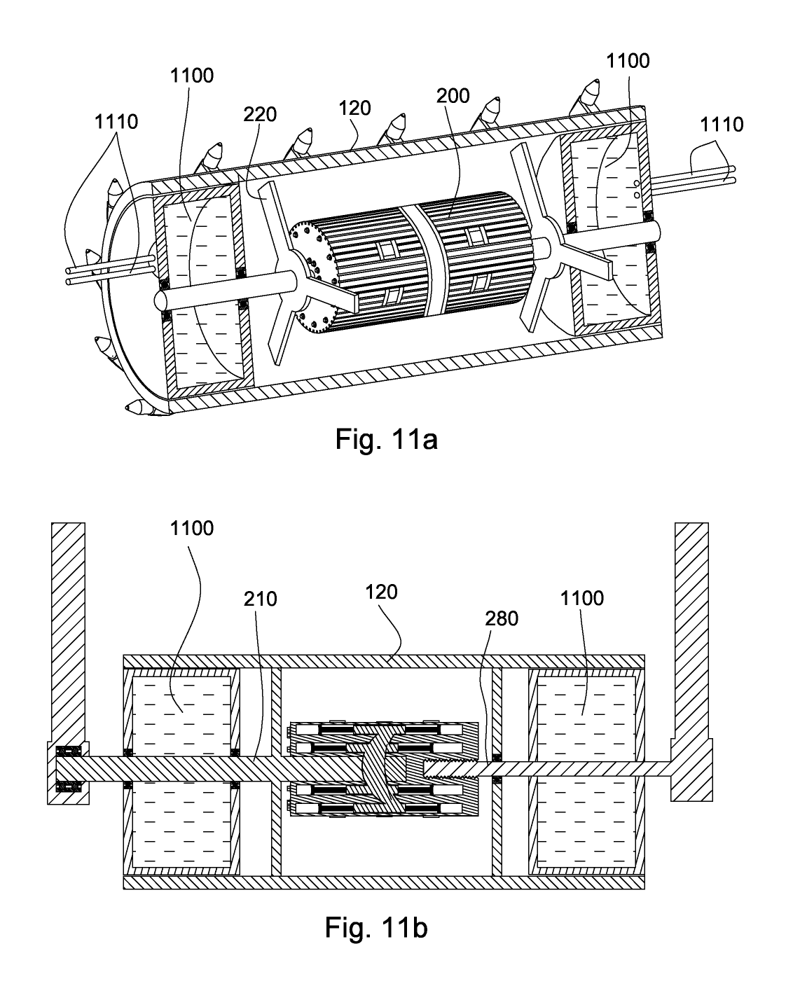

FIG. 11a discloses a perspective diagram of an embodiment of the degradation drum 120 comprising the engine 200 and a plurality of hydraulic reservoirs 1100. The hydraulic reservoir 1100 may be positioned on both sides of the engine 200 such that load on the drum 120 is uniformly distributed. The hydraulic reservoir 1100 may be connected to a hydraulic circuit of the milling machine 100 via pipes 1110. The hydraulic reservoir 1100 may be supported by at least one supporting rod 220 attached to the inner diameter of the degradation drum 120. The hydraulic reservoirs 1100 along with the engine 200 are believed to increase the weight of the degradation drum 120. Thus, the drum 120 is much heavier compared to the rest of the machine 100.

Referring to FIG. 11b, the rotating shaft 210 may be connected to the hydraulic reservoirs 1100 by a bearing mechanism such that the shaft 210 may rotate while keeping the reservoir 1100 stationary. The non-rotating shaft 280 may be connected to the reservoir by a bolt or welding mechanism. The reservoirs 1100 may remain disconnected to the inner surface of the drum 120 so that the reservoirs 1100 may remain stationary.

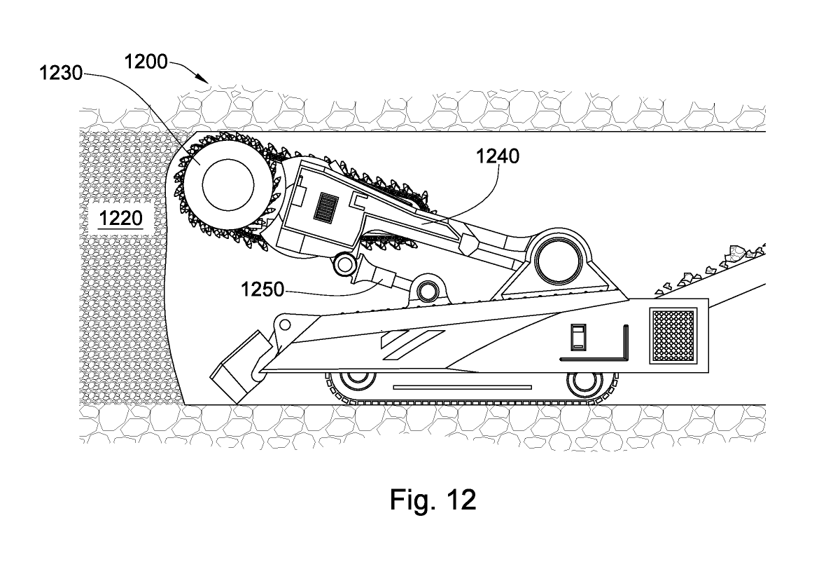

FIG. 12 is an orthogonal diagram of an embodiment of a coal excavator 1200. The present invention may be incorporated into the coal excavator 1200. The cutting elements may be connected to the degradation drum 1230 that is degrading the coal 1220. The rotating drum 1230 is connected to an arm 1240 that moves the drum 1230 vertically in order to engage the coal 1220. The arm 1240 may move by a hydraulic arm 1250, it may also pivot about an axis or a combination thereof. The coal excavator 1200 may move about by tracks, wheels, or a combination thereof. The coal excavator 1200 may also move about in a subterranean formation.

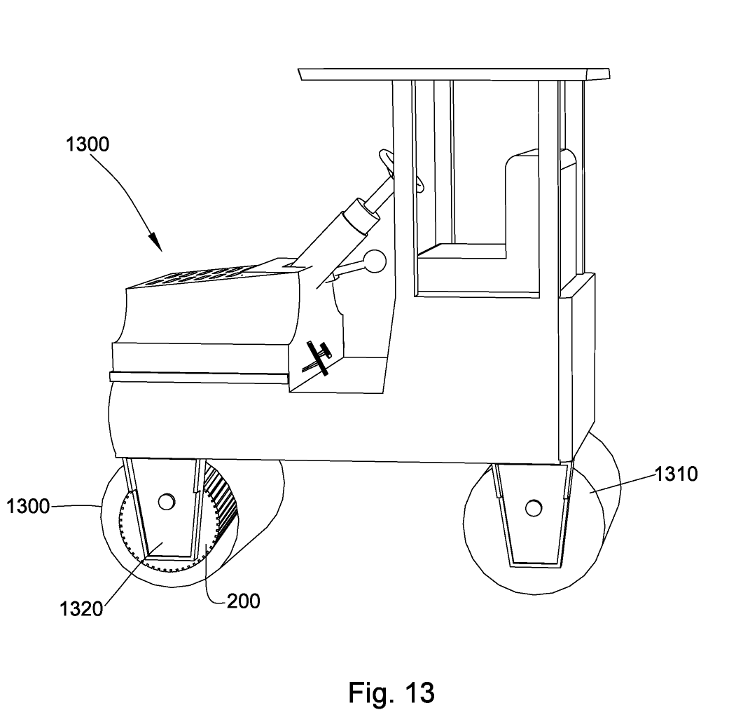

FIG. 13 discloses a perspective diagram of an, embodiment of a steam roller 1300 comprising a rotary drive device such as engine 200 inside one of its drums 1310. The present invention may be incorporated into a compactor such as the steam roller 1300. The engine 200 may be supported by an axle 1320 of the drum 1310. In some embodiments, both the drums 1310 may comprise a rotary drive device such as engine, motor, or combinations thereof. The rotary drive device inside the drum 1310 may increase the weight of the drum 1310. The steam roller 1300 comprising heavy drums 1310 may be beneficial in leveling surfaces such as roads or airfields.

Whereas the present invention has been described in particular relation to the drawings attached hereto, it should be understood that other and further modifications apart from those shown or suggested herein, may be made within the score and spirit of the present invention.

What is claimed is:

1. A motorized machine, comprising:
at least one rotary assembly supported by a frame of the machine;
a rotary drive device disposed within an inner diameter of the rotary assembly; and
the rotary drive device is configured to rotate the rotary assembly with respect to the frame.

2. The machine of claim 1, wherein the rotary assembly is a degradation drum with a plurality of cutting elements.

3. The machine of claim 1, wherein the rotary assembly is a compactor.

4. The machine of claim 1, wherein the rotary drive device is an electric motor.

5. The machine of claim 1, wherein the rotary drive device is interlocked within an inner diameter of the rotary assembly.

6. The machine of claim 1, wherein the rotary drive device is an axial vector engine.

7. The machine of claim 1, wherein the rotary drive device is a wankel engine.

8. The machine of claim 1, wherein the rotary drive device comprises a connecting rod that connects to the inner surface of the rotary assembly.

9. The machine of claim 1, wherein the rotary drive device comprises a gear set that connects to the inner surface of the rotary assembly.

10. The machine of claim 1, wherein the rotary drive device is a hydraulic motor.

11. The machine of claim 1, wherein the degradation drum further comprises a hydraulic reservoir.

12. The machine of claim 11, wherein the hydraulic reservoir is connected to a hydraulic circuit supported by the frame of the machine.

13. The machine of claim 1, wherein the rotary drive device is in electrical communication with a power source supported by the frame of the machine via an electrically conductive medium.

14. The machine of claim 13, wherein the electrically conductive medium comprises a swivel joint located along a rotational axis of the rotary assembly.

15. The machine of claim 1, wherein the rotary assembly weighs at least 30 percent of the total weight of the motorized machine.

16. The machine of claim 15, wherein the machine comprises a light weight truss that supports the assembly, the truss comprising carbon fiber, aluminum, aerogels, metal matrix composites, or combinations thereof.

17. The machine of claim 1, wherein the rotary drive device is controlled by an operator via a control panel, remote control, or combinations thereof.

18. The machine of claim 1, wherein the rotary drive device is powered by an external power source.

19. A milling machine, comprising:
at least one milling drum supported by a frame of the machine;
an engine disposed within an inner diameter of the drum;
the engine being configured to rotate the drum with respect to the frame;
a combined weight of the engine and the drum being amounting to at least half of the total weight of the milling machine.

20. The machine of claim 1, wherein the rotary drive device is held stationary with respect to the frame.
